(19) United States
(12) Patent Application Publication
(10) Pub. No.: US 2013/0236332 A1
(43) Pub. Date: Sep. 12, 2013

(54) Systems and Methods for Cooling High Temperature Electrical Connections

(71) Applicants: Jeffrey G. Frey, Broken Arrow, OK (US); Adam L. Gibson, Claremore, OK (US); Donald R. Lingenfelter, Claremore, OK (US); Terry L. Glasscock, Vinita, OK (US)

(72) Inventors: Jeffrey G. Frey, Broken Arrow, OK (US); Adam L. Gibson, Claremore, OK (US); Donald R. Lingenfelter, Claremore, OK (US); Terry L. Glasscock, Vinita, OK (US)

(21) Appl. No.: 13/414,640

(22) Filed: Mar. 7, 2012

(51) Int. Cl. F04B 53/00; H01R 43/00; H01R 13/46

(52) U.S. Cl. 417/313; 439/485; 29/825

(57) ABSTRACT

Systems and methods for cooling a pothead connector that couples a power cable to the motor of an ESP system, wherein a heat dissipation structure is provided on the connector to increase the transfer of heat from the connector to the surrounding well fluid. In one embodiment, the connector has a housing through which conductors from the power cable extend to a set of terminals which are configured to mate with complementary terminals of the motor. Heat dissipation structures such as fins are provided on the connector housing to facilitate the transfer of heat from the connector to the surrounding well fluid. Baffles or flow diverters may be positioned near the fins to cause turbulence or increased fluid flow near the fins, thereby increasing the heat transfer and improving the cooling of the pothead connector.

### BACKGROUND

1. Field of the Invention

The invention relates generally to downhole electric equipment, and more particularly to systems and methods for improving the reliability of electrical connections between downhole electric equipment and the drive systems that are used to supply power to the motors.

2. Related Art

Electric submersible pump (ESP) systems are commonly positioned deep within subterranean wells and used to pump fluids from the wells. Power suitable to drive the ESP systems is produced at the surface of the wells and is delivered to the ESP systems via power cables that extend into the wells. The power cables typically have one or more electrical junctions, such as splices to motor leads and “pothead” connectors that couple the power cable to the down hole equipment (e.g., an ESP motor).

The environment downhole in the wells may be very harsh. For instance, the temperature may be several hundred degrees, the fluids in the wells may be corrosive, and particles in the fluids may be abrasive. These conditions can cause the components of an ESP system to degrade and possibly fail, thereby shortening the useful life of the ESP system.

High temperatures downhole are increasingly problematic. The temperature of the geological formation in which a well has been drilled is often high (e.g., 300 degrees F.) even in the absence of the downhole equipment. When an ESP system is operated downhole, it generates additional heat that increases the temperature around the system. The problem of high environmental temperatures is made even worse when techniques such as SAGD (steam assist, gravity drain) are employed to heat oil in the formation, thereby reducing its viscosity and facilitating pumping.

Conventionally, concerns about high temperatures and their effects on downhole equipment such as ESP systems have focused on major components of the systems. In particular, attention has been directed to the motors used in ESP systems. For example, efforts have been made to increase the efficiency of these motors (thereby reducing the amount of heat they generate), to provide means to dissipate heat from the motors, and to use materials that withstand increasingly high temperatures.

Other potential points of failure include the electrical junctions in the power cable. The junctions at the splices and at the connector between the power cable and the motor wiring are subject to resistive heating that further increases the temperature at these junctions. Because the temperature may already be near the limits of the materials (e.g., insulators) used at these junctions, the additional heating may cause the materials to degrade or fail. For instance, the electrical insulation around the power cables may begin to soften and/or lose its electrically insulating properties, which may result in a short circuit that causes the system to fail.

### SUMMARY OF THE INVENTION

This disclosure is directed to systems and methods for cooling the junctions (e.g., splices and pothead connectors) that couple the power cable to downhole electrical equipment such as the motor of an ESP system, wherein a heat dissipation structure is provided at the junctions to increase the transfer of heat from the junctions to the surrounding well fluid.

One embodiment comprises an electrical connector coupled between a surface power source and electrical equipment positioned downhole in a well. The connector includes a housing, into which a first conductor extends from a first end and a second conductor extends from a second end, wherein the first conductor is electrically coupled to the second conductor at a junction within the housing. The housing includes one or more heat dissipation structures which facilitate heat transfer from the junction to well fluid which is external to the housing. The electrical connector may, for example, be a splice connector or a pothead connector. The heat dissipation structures comprise fins or other structures protruding outward from the housing to increase the external surface area of the housing. Baffles or flow diverters may be positioned on or near the housing to create turbulence in the well fluids near the heat dissipation structures, or to increase the flow of well fluids by the heat dissipation structures.

An alternative embodiment comprises a pothead connector for coupling a power cable to a downhole motor. The connector has a housing into which one or more conductors from the power cable extends. The conductors pass through the housing and terminate at corresponding terminals which are configured to mate with complementary terminals of the motor. One or more heat dissipation structures are thermally coupled to the connector housing to facilitate the transfer of heat from the connector to the surrounding well fluid. The heat dissipation structures may be, for example, fins that protrude outward from the housing. The heat dissipation structures may be integral to the housing, or they may be separate components that are connected to the housing in a manner that provides good thermal conductivity between them. The heat dissipation structures may be positioned on a front side of the connector that faces away from a motor. Alternatively, the heat dissipation structures may be positioned on another side of the connector, and one or more flow diverters may be positioned to redirect flow of well fluids toward the heat dissipation structures. Baffles may be provided to produce turbulence in the well fluids that flow by the heat dissipation structures.

Another embodiment comprises an ESP system comprising that includes a pump and a motor coupled to the pump. The ESP system is configured to be positioned downhole in a well and operated to pump fluids from the well. The motor receives power from a drive system at the surface of the well. A power cable is coupled between the drive system and the motor. The power cable is coupled to the motor via a pothead connector that has one or more heat dissipation structures thermally coupled to the housing of the connector. The heat dissipation structures may be fins that protrude outward from the housing or other types of structures. The heat dissipation structures may be integral to the housing, or they may be separate components. Flow diverters may be positioned to redirect flow of well fluids toward the heat dissipation structures. Baffles may be provided to produce turbulence in the well fluids that flow by the heat dissipation structures.

Yet another embodiment comprises a method. The method includes providing a pothead connector whose housing has one or more heat dissipation structures, coupling the pothead connector between a power source and a motor of an ESP system, positioning the ESP system downhole in a well, and operating the ESP system. Operating the ESP system causes well fluids to flow by the heat dissipation structures, thereby transferring heat from the pothead connector to the well fluids.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary ESP system in accordance with one embodiment.

FIG. 2 is a diagram illustrating the structure of a pothead connector installed at the top of an ESP motor in accordance with one embodiment.

FIG. 3 is a diagram illustrating the structure of a splice connector in accordance with one embodiment.

FIG. 4 is a diagram illustrating a side view of an exemplary embodiment of a pothead connector in which fins are provided on the front surface of the pothead housing.

FIG. 5 is a front view of the pothead connector of FIG. 3.

FIG. 6 is a perspective view of the pothead connector of FIG. 3.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for improving the reliability of downhole electric equipment such as ESP systems by improving the cooling of electrical connections (e.g., splices and pothead connectors) that couple power cables to the ESP systems.

In one embodiment, a three-phase power cable has a first end coupled to a drive system at the surface of a well and a second end that is spliced to one end of a motor lead. The other end of the motor lead is connected to a pothead connector. The conductors of the power cable are connected to the conductors of the motor lead within a splice housing. The conductors of the motor lead are connected to the terminals of the pothead within the pothead housing. The junctions of the conductors and terminals in the splice and pothead are surrounded by electrically insulating material to prevent short circuits between them.

Because extremely high temperatures may cause the insulating material to degrade both physically and in terms of its electrically insulating properties, heat dissipating structures are thermally coupled to the housings of the splice and pothead connector. For instance, the housings may be manufactured with a series of fins that protrude outward from the outer surface of the housings. These fins provide increased surface area on the exterior of the housings, which enables greater heat transfer from the housings to the surrounding well fluid. Baffles or flow diverters may also be positioned near the fins to cause turbulence or increased fluid flow near the fins, thereby increasing the heat transfer and improving the cooling of the splice and pothead connector.

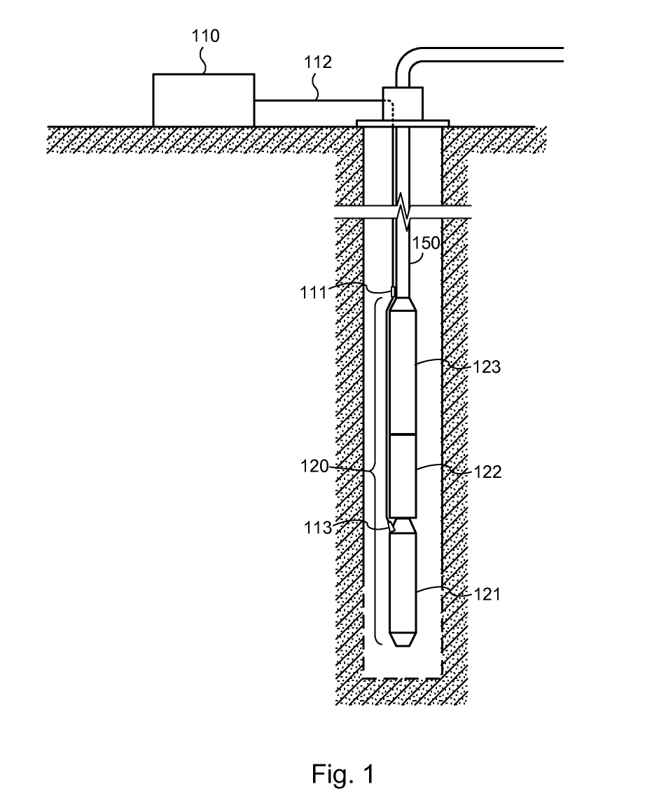

Referring to FIG. 1, a diagram illustrating an exemplary system in accordance with one embodiment of the present invention is shown. In this embodiment, an ESP system is installed in a well for the purpose of producing oil, gas or other fluids. An ESP 120 is coupled to the end of tubing string 150, and the ESP and tubing string are lowered into the wellbore to position the ESP in a producing portion of the well (as indicated by the dashed lines at the bottom of the wellbore). Surface equipment that includes a drive system 110 is positioned at the surface of the well. Drive system 110 is coupled to ESP 120 by power cable 112, which runs down the wellbore along tubing string 150. Tubing string 150 and power cable 112 may range from less than one thousand feet in a shallow well, to many thousands of feet in a deeper well.

ESP 120 includes a motor section 121, seal section 122, and pump section 123. ESP 120 may include various other components which will not be described in detail here because they are well known in the art and are not important to a discussion of the invention. Motor section 121 is operated to drive pump section 123, thereby pumping the oil or other fluid through the tubing string and out of the well. Drive system 110 produces power (e.g., three-phase AC power) that is suitable to drive motor section 121. This output power is provided to motor section 121 via power cable 112.

Power cable 112 may, for example, include two components: a primary cable component and a motor lead component. The primary cable extends downward along the tubing string from the drive unit at the surface of the well to a point near the ESP. At this point (typically 10-50 feet above the ESP), the primary cable is connected to the motor lead by a splice 111. The motor lead extends from the primary cable to the motor, and is connected to the motor by a connector 113, which may be referred to as a “pothead”. At the pothead, the electrical conductors of the motor lead are coupled to the internal wiring of the motor.

The primary cable typically has three conductors to carry three-phase power to the motor. Each conductor has one or more layers of electrical insulation. The conductors may be positioned side-by-side to form a flat cable, or they may be positioned adjacent to each other (i.e., 120 degrees apart) to form a round cable. An elastomeric coating may be provided to encase the three conductors, and a metal layer may be provided over the elastomeric layer to protect the insulated conductors.

The motor lead is coupled to the primary cable, normally by splicing the respective conductors together. The conductors of the motor lead have one or more layers of electrical insulation and are usually encased in an elastomeric layer. The conductors are typically positioned side-by-side in a flat configuration, and the conductors of the motor lead may be smaller than the conductors of the primary cable to allow the motor lead to fit more easily between the ESP and the well casing. A metal layer may be provided over the elastomeric layer to protect the insulated conductors.

The motor lead is coupled to the primary cable, normally by splicing the respective conductors together. This splice may be achieved by coupling a splice connector between the end of each of the conductors of the primary cable and the corresponding conductor of the motor lead. Thus, three splice connectors would be used to couple the three conductors of the primary cable to the three conductors of the motor lead. At the other end of the motor lead, each of the conductors of the motor lead is connected to a corresponding terminal in the pothead connector. The pothead is secured to the motor housing with its terminals connected to complementary terminals of the motor.

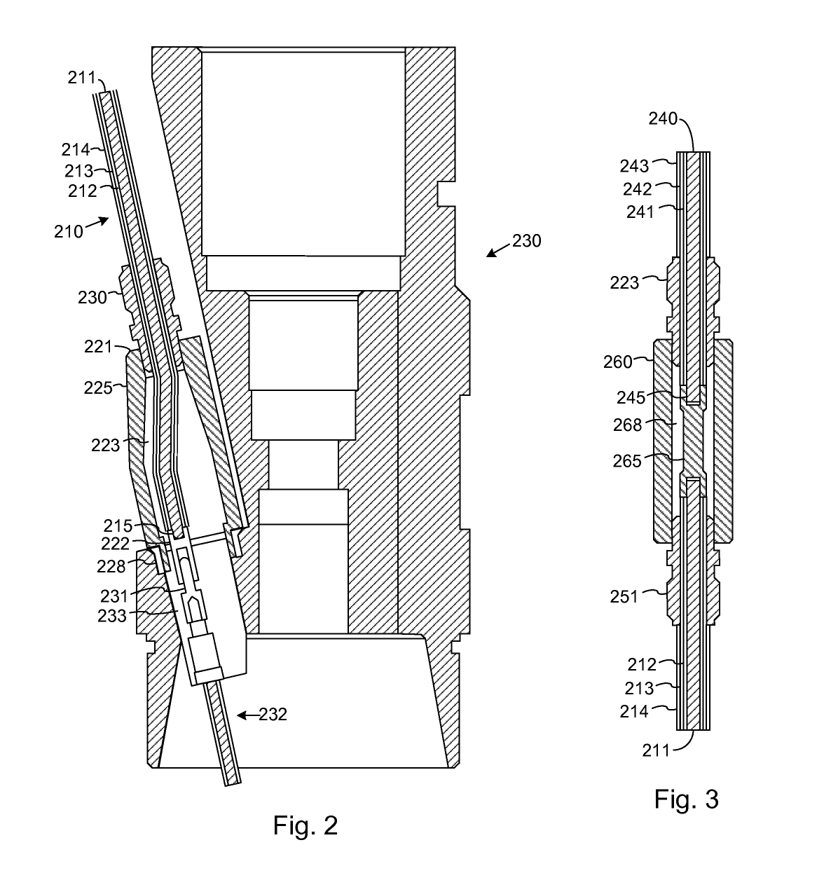

Referring to FIG. 2, a cutaway view of a pothead connector installed at the top of an ESP motor is shown. The illustrated structures are exemplary, and may differ from one embodiment to another. In this embodiment, motor lead 210 is coupled to pothead connector 220, which is secured to motor head 230. A single one of the conductors of motor lead 210 is depicted in the figure. Electrical conductor 211 is encased in a layer of electrical insulation 212. A layer of elastomeric material 213 covers insulating layer 212. A protective metal layer 214 is provided to prevent damage to the motor lead when the motor is installed in the well.

Conductor 211 passes through ferrule 230 at an upper or lead end of pothead connector 220 and into the body of the connector. In the embodiment of FIG. 2, protective metal layer 214 is trimmed so that it terminates at the top of ferrule 230. Elastomeric layer 213 extends through ferrule 230, but is trimmed so that it does not extend into pothead housing 221. Insulating layer 212 extends through ferrule 230 and into pothead housing 221. The terminal end (215) of conductor 211 is connected to a conductive female terminal 222, which is positioned at a lower or motor end of the pothead connector. Female terminal 222 is configured to mate with a male terminal 231 of motor head 230. Male terminal 231 is electrically coupled to the internal wiring 232 of the motor. A seal 228 is provided between pothead connector 220 and motor head 230.

Within housing 221 of pothead 220, conductor 211 is embedded in an electrically insulating material 223. In some embodiments, the conductor may be partially embedded in an epoxy material. As noted above, the motor is typically configured to utilize three-phase power, so insulating material 223 provides electrical insulation between the three different conductors within pothead connector 220 that carry the three phases of power. Additional insulating material 233 may likewise be provided around the male terminals of motor head 230 to electrically isolate the three phases of power.

As noted above, the ESP system, including the motor and the pothead connector, may be subject to very high temperatures resulting from the relatively high static temperature of the formation, to which is added the heat generated by the motor, heat provided by the injection of steam in the well, and heat generated by the junction of the power cable/motor lead conductors with the motor's internal wiring at the pothead connector. The cooling of the system is dependent upon on the transfer of heat to well fluids which are pumped out of the well. While conventional ESP systems may be designed to increase heat dissipation from the motor itself, they do not address heat dissipation through the pothead connector, and do not address the additional resistive heating that is produced at the junction of the pothead connector. In fact, because seal 228 typically thermally insulates housing 221 from the motor housing, means for cooling the motor are typically ineffective to cool the pothead connector.

The present systems and methods address the heating of the pothead connector by providing heat dissipation structures in the pothead connector itself. For example, in one embodiment, the front (225) of pothead housing 221 (the portion which faces away from the motor) includes fins which increase the external surface area of the pothead and thereby enable increased heat transfer from the pothead connector to the well fluids. The heat dissipation fins may be formed, for instance, by machining grooves into front surface 225 of pothead housing 221. Front surface 225 is exposed to the flow of well fluids around the ESP. As these fluids flow across the fins formed in the front surface of the pothead housing, heat is transferred from the fins to the fluid. The heat can then be removed from the well with the fluid.

Referring to FIG. 3, a cutaway view of an exemplary splice connection between corresponding conductors of a primary cable and a motor lead is shown. In this embodiment, a conductor 240 of the primary power cable is inserted through ferrule 250 and into the housing 260 of the splice connector. Conductor 240 is insulated by an electrically insulating layer 241, which is covered by an elastomeric layer 242. A protective metal layer 243 surrounds the elastomeric layer, but is trimmed to terminate at ferrule 250. The end 245 of conductor 240 is connected to a pin 265 at the center of the splice connector. At the lower end of the splice connector, motor lead conductor 211 extends through ferrule 251 and into housing 260. An upper end 216 of motor lead conductor 211 is connected to the lower end of pin 265. Insulating material 268 is provided to electrically insulate conductors 211 and 240 and pin 265 within housing 260. Each pair of conductors (one conductor of the primary power cable and one conductor of the motor lead) is coupled together using a similar splice connector.

Housing 260 of the splice connector includes heat dissipation structures which may be similar to those of the pothead connector. For instance, the heat dissipation structures may include fins or other structures which protrude outward from the external surface of housing 260. Resistive heating at the junction of the conductors is then dissipated outward through the housing and fins to the surrounding well fluids. The heat dissipation structures of the splice connector are necessary because the splice connector is physically separated from the motor by a significant distance (the length of the motor lead), making cooling means at the motor ineffective to dissipate heat at the splice connector.

It should be noted that the exemplary structures of the pothead and splice connectors described above are provided to illustrate the sources of the resistive heating (the electrical junctions) within the connectors, and the present systems and methods may be applied to alternative structures as well. For instance, while the connectors of FIGS. 2 and 3 use ferrules to secure the respective conductors within the housings, alternative embodiments may use epoxies or other means to secure the conductors. Other details of the internal structures may also vary in alternative embodiments.

It should also be noted that, while the splice connector described above is used to couple the a primary power cable to a motor lead, it can also be used to couple segments of power cable together, and is not limited to embodiments in which primary power cables are connected to motor leads.

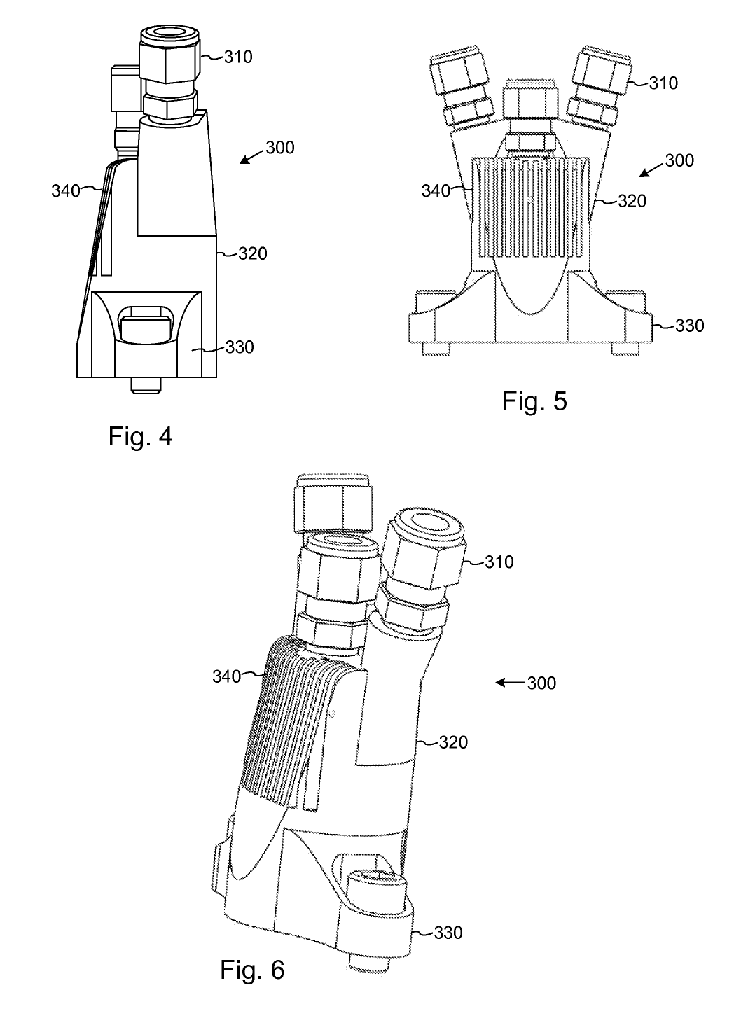

FIGS. 4-6 depict an exemplary embodiment of a pothead connector in which fins are formed by machining grooves into the front surface of the pothead housing. In these figures, the pothead connector is shown without the motor leads. FIG. 4 is a side view of the pothead connector. FIG. 5 is a front view of the pothead connector. FIG. 6 is a perspective view of the pothead connector.

It can be seen in FIGS. 4-6 that the pothead connector 300 is configured to have three conductors of a motor lead coupled to the connector. Each of the three conductors is secured to the pothead connector through a corresponding ferrule (e.g. 310). Within housing 320 of pothead connector 300, each conductor is connected to a corresponding terminal that is accessible at the bottom of the connector to enable it to be coupled with a corresponding terminal of the motor. A pair of tangs (e.g., 330 having bolts (e.g., 340) therethrough extend outward from the bottom of pothead connector 300 to allow the connector to be secured to a motor head.

On the front of pothead housing 320, a series of grooves are machined into the housing to form fins (e.g., 340). The fins are formed on the front of pothead housing 320 (facing away from the ESP motor) so that they will be exposed to fluid flowing along the exterior of the ESP motor. Fins or other heat dissipating structures may also be positioned on other portions of the pothead housing. If, for example, a heat dissipating structure is positioned on the side or back of the pothead housing, it may be desirable to provide a flow diverter on or near the pothead housing to direct the flow of fluid toward the heat dissipating structure. Such flow diverters may consist of fins that are positioned to redirect fluid toward the heat dissipating structure. Baffles may also be provided to increase the turbulence of fluid flowing over the heat dissipating structures, thereby increasing heat transfer from the structures to the fluid.

Although not separately illustrated, the housing of an exemplary splice connector may employ fins similar to those shown in FIGS. 4-6 as heat dissipation structures. These fins may be formed by machining grooves into the external surface of the splice connector housing. The fins may also be formed by other means, or the splice connector housing may have heat dissipation structures other than fins. Baffles or flow diverters may be used with the splice connectors as well as the pothead connectors.

It should be noted that the word “fins” is used herein to describe relatively flat, thin structures that protrude outward from the pothead housing. This term is intended to be construed broadly to include such structures that may have different lengths, thicknesses, depths or other dimensions than those explicitly shown in the figures. It should also be noted that heat dissipation structures may be provided which might not be accurately characterized as fins. Such structures may nevertheless serve the same heat dissipation function as the fins described above, and may therefore characterize some embodiments of the present systems and methods. A heat dissipation structure may be integral to the housing of the pothead connector, or it may be a separate component that is otherwise thermally coupled to the housing.

It is further noted that, although any material necessarily transfers some amount of heat, and consequently any pothead connector could be construed to dissipate heat, conventional pothead connectors are not designed or intended to dissipate any significant amount of heat. Conventional pothead connectors are instead designed to provide an electrical connection, to electrically insulate the various conductors of the connection, and to protect the connection. Therefore, terms such as “heat dissipation structure” which are used herein, are intended to be construed to include structures which are designed to provide greater heat transfer than structures such as conventional pothead connector housings that are not designed or intended for this purpose. Consequently, a conventional pothead connector having a smooth, relatively flat outer surface with no protrusions that serve merely to increase the external surface area of the connector are not considered, for the purposes of this disclosure, to include a heat dissipation structure.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. An electrical connection coupled between a surface power source and electrical equipment positioned downhole in a well, wherein the connection comprises:
a housing;
a first conductor extending into the housing from a first end of the housing;
a second conductor extending into the housing from a second end of the housing;
wherein the first conductor is electrically coupled to the second conductor at a junction within the housing;
wherein the housing includes one or more heat dissipation structures which facilitate heat transfer from the junction to well fluid external to the housing.

2. The connection of claim 1, wherein the one or more heat dissipation structures comprise fins protruding outward from the housing.

3. The connection of claim 2, wherein the fins are integral to the housing.

4. The connection of claim 1, wherein the connection comprises a splice connector that couples a first power cable to a second power cable.

5. The connection of claim 1, wherein the connection comprises a pothead connector that couples a power cable to an electric motor.

6. The connection of claim 5, wherein the fins are positioned on a front side of the connector that faces away from a motor to which the connector is secured.

7. The connection of claim 1, further comprising one or more baffles, wherein the baffles are configured to produce turbulence in the well fluid flowing by the connector.

8. The connection of claim 1, further comprising one or more flow diverters, wherein the flow diverters are configured to redirect flow of well fluids toward at least one of the heat dissipation structures.

9. An electric submersible pump system comprising:
A power source;
a pump;
a motor coupled to drive the pump;
a power cable coupled between the power source and the motor; and
wherein the power cable includes at least one electrical connection, and wherein the electrical connection includes a housing and one or more heat dissipation structures thermally coupled to the housing.

10. The electric submersible pump system of claim 9, wherein the one or more heat dissipation structures comprise fins protruding outward from the housing.

11. The electric submersible pump system of claim 9, wherein the electrical connection comprises a pothead connector coupled to a housing of the motor.

12. The electric submersible pump system of claim 11, wherein the fins are positioned on a front side of the pothead connector that faces away from the housing of the motor.

13. electric submersible pump system of claim 9, wherein the connection comprises a splice connector that couples a first portion of the power cable to a second portion of the power cable.

14. The electric submersible pump system of claim 9, further comprising one or more baffles, wherein the baffles are configured to produce turbulence in well fluids flowing by the electrical connection.

15. The electric submersible pump system of claim 9, further comprising one or more flow diverters, wherein the flow diverters are configured to redirect flow of well fluids toward at least one of the heat dissipation structures.

16. A method comprising:
providing an electrical connection that includes a housing and one or more heat dissipation structures thermally coupled to the housing;
electrically coupling the electrical connection between a power source and a piece of downhole electric equipment;
positioning the piece of downhole electric equipment downhole in a well; and
operating the piece of downhole electric equipment, wherein heat from the electrical connection is transferred through the heat dissipation structures to well fluid in the well.

17. The method of claim 16, wherein the electrical connection comprises a pothead connector and wherein electrically coupling the electrical connection between the power source and the piece of downhole electric equipment comprises securing the pothead connector to a housing of a motor of an electric submersible pump system.

18. The method of claim 17, wherein the pothead connector is secured to the motor with the heat dissipation structures facing away from the motor.

19. The method of claim 16, further comprising providing one or more baffles near the electrical connection and thereby producing turbulence in well fluids flowing by the electrical connection.

20. The method of claim 16, further providing one or more flow diverters near the electrical connection and thereby redirecting the flow of well fluids toward at least one of the heat dissipation structures.
